(19) United States
(12) Patent Application Publication
(10) Pub. No.: US 2022/0045577 A1
(43) Pub. Date: Feb. 10, 2022

(54) ELECTRIC MOTOR FOR AN AXLE ASSEMBLY

(71) Applicant: ALLISON TRANSMISSION, INC., Indianapolis, IN (US)

(72) Inventors: Christopher G. BAILLIE, Lake Orion, MI (US); Shaun MEPHAM, Clarkston, MI (US)

(21) Appl. No.: 17/280,668

(22) PCT Filed: Sep. 27, 2019
(86) PCT No.: PCT/US2019/053457

§ 371 Date: Mar. 26, 2021

Related U.S. Application Data
(60) Provisional application No. 62/737,510, filed on Sep. 27, 2018.

(51) Int. Cl. H02K 9/193; H02K 5/20; H02K 3/24; H02K 1/16; H02K 1/20; H02K 7/14

(52) U.S. Cl. CPC H02K 9/193; H02K 5/20; H02K 7/14; H02K 1/16; H02K 1/20; H02K 3/24

(57) ABSTRACT

An electric motor for use in an axle assembly. The electric motor includes a stator having a stator core, and a rotor adapted for rotation about a rotor axis within the stator core. The stator includes a series of conductive windings that are disposed about the stator core. The windings are wound in a direction generally parallel to the rotor axis and protrude from first and second ends of the stator core. The stator core is formed to include a plurality of longitudinal passageways that are radially arranged about the stator core and are adapted to permit the flow of a cooling fluid through the passageways. The passageways of the stator core extend longitudinally through the stator core and are positioned between the windings such that heat generated by the windings is transferred to the cooling fluid to remove heat from the windings. The motor also includes a metering ring coupled to a first end of the stator core and a discharge ring coupled to a second end of the stator core. The rings are adapted to direct the flow of cooling fluid through the passageways of the stator core to remove heat from the windings generated by operation of the electric motor.

### CROSS REFERENCE TO RELATED APPLICATIONS

This application claims the benefit of priority under 35 U.S.C. § 119(e) to U.S. Provisional Patent Application No. 62/737,510, filed 27 Sep. 2018. The disclosure set forth in the referenced application is incorporated herein by reference in its entirety.

### BACKGROUND

There is a growing demand for vehicles that generate reduced or zero emissions during operation. Increasingly, vehicle manufacturers have turned to electric and hybrid propulsion systems to reduce vehicle emissions and increase efficiency. These electric propulsion systems typically utilize one or more axle assemblies powered by an electric machine, such as an electric motor that provides motive power to the vehicle's wheels. In order to improve packaging in a variety of different vehicle types and to promote simplified assembly, the electric motors may be integrated with the axle assembly.

Accordingly, there is a need to provide an electric motor that is capable of operation in conditions occurring within the axle assembly while optimizing efficiency, performance, and cost.

### SUMMARY

In accordance with the present disclosure, an electric motor is used with an axle assembly.

In illustrative embodiments, the electric motor for an axle assembly includes a stator having a stator core and a rotor adapted for rotation about a rotor axis within the stator core. The stator includes a series of conductive windings that are disposed about the stator core. The windings are wound around the stator core in a direction generally parallel to the rotor axis.

In illustrative embodiments, the stator core is formed to include a plurality of longitudinal passageways that are radially arranged about the stator core and are adapted to permit the flow of a cooling fluid through the passageways. The passageways of the stator core extend longitudinally through the stator core and are positioned between the windings such that heat generated by the windings is transferred to the cooling fluid to remove heat from the windings.

In illustrative embodiments, the motor also includes a metering ring coupled to a first end of the stator core and a discharge ring coupled to a second end of the stator core. The rings are adapted to direct the flow of cooling fluid through the passageways of the stator core to remove heat from the windings generated by operation of the electric motor.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

Other advantages of the present invention will be readily appreciated as the same becomes better understood by reference to the following detailed description when considered in connection with the accompanying drawings.

FIG. 1 is a perspective view of a first axle assembly according to embodiments of the present invention.

FIG. 2 is a perspective view of the first axle assembly, shown in FIG. 1, with a cover removed to show a gear train, and an electric motor and a cooling system of the present invention.

FIG. 3 is a perspective view of the axle assembly, shown in FIG. 2, with a housing removed to show the gear train, and the electric motor and the cooling system of the present invention.

FIG. 4 is a perspective view of a second axle assembly according to embodiments of the present invention.

FIG. 5 is another perspective view of the axle assembly shown in FIG. 4.

FIG. 6 is a perspective view of the axle assembly shown in FIG. 4 with a housing removed to show a gear train, two electric motors and a cooling system of the present invention.

FIG. 7 is a perspective view of the gear train of the first axle assembly, the electric motor, and cooling system of the present invention.

FIG. 8 is another perspective view of the electric motor and cooling system shown in FIG. 7.

FIG. 9 is a rear perspective view of the electric motor including a stator, with the stator shown partially transparent.

FIG. 10 is a cross-sectional front perspective view of the electric motor and stator shown in FIG. 9.

FIG. 11 is a partial perspective view of the electric motor and stator of FIG. 9 taken through a slot defined in the stator.

FIG. 12 is a partial sectional view of the electric motor and stator of FIG. 9 taken through a fastener.

FIG. 13 is another sectional front perspective view of the electric motor and stator shown in FIG. 9.

FIG. 14 is a cross-sectional view of the electric motor and stator of FIG. 9 disposed in a housing.

FIG. 15 is another cross-sectional view of the electric motor and stator disposed in the housing of FIG. 14

FIG. 16 is a front perspective view of the electric motor including a stator and a rotor.

FIG. 17 is an enlarged front perspective view of the stator and rotor of FIG. 16 showing the slots defined in the stator.

FIG. 18A is a schematic view of the cooling system of the present invention.

FIG. 18B is a diagram of the slots defined in the stator and graph of flow rate through the slots.

FIG. 19 is a perspective view of a clamp ring, a metering ring, and a discharge ring.

FIG. 20 is another perspective view of the clamp ring and metering ring of FIG. 19.

FIG. 21 is another perspective view of the metering ring of FIG. 20.

FIG. 22 is an enlarged perspective view of the metering ring of FIG. 20.

FIG. 23 is a perspective view the discharge ring of FIG. 19.

FIG. 24 is a perspective view of the rotor shown in FIG. 16.

FIG. 25 is an enlarged perspective view of the electric motor and rotor.

FIG. 26 is a perspective view of the electric motor assembly.

FIG. 27 is a sectional view taken along line 27-27 of FIG. 26.

FIG. 28 is an enlarged view of FIG. 27.

FIG. 29 is a sectional view taken along line 29-29 of FIG. 26.

FIG. 30 is a sectional view taken along line 30-30 of FIG. 26.

FIG. 31 is a sectional view taken along line 31-31 of FIG. 26

### DETAILED DESCRIPTION

With reference to the Figures, wherein like numerals indicate like parts throughout the several views, the present invention includes an electric axle assembly 100 for use with a vehicle such as for example, a body-on-frame truck. In the embodiment shown, wheels are arranged at opposing ends of the electric axle assembly 100 to support the vehicle for conveyance along a ground surface. The electric axle assembly 100 propels the vehicle by transferring motive power to the wheels for rotation along the ground.

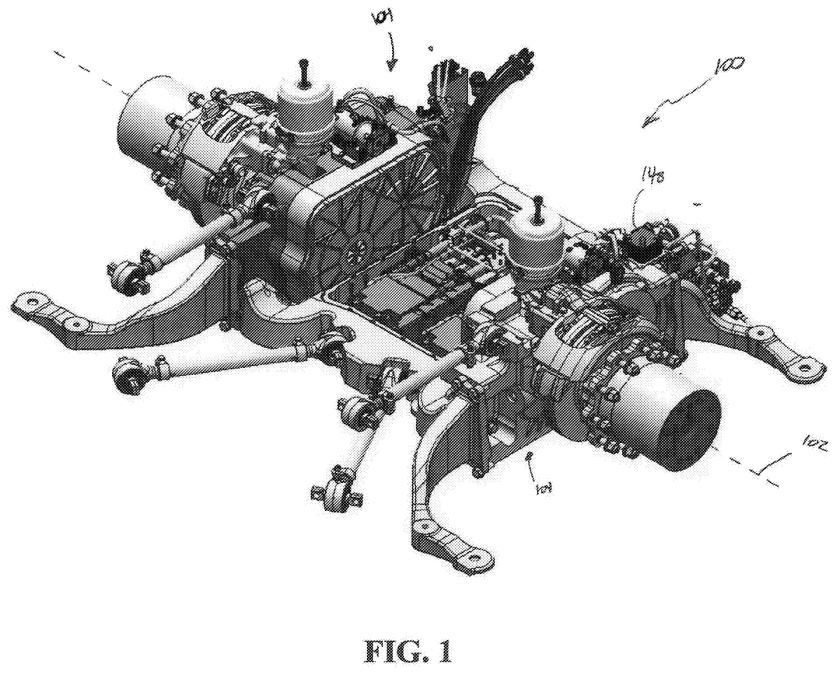

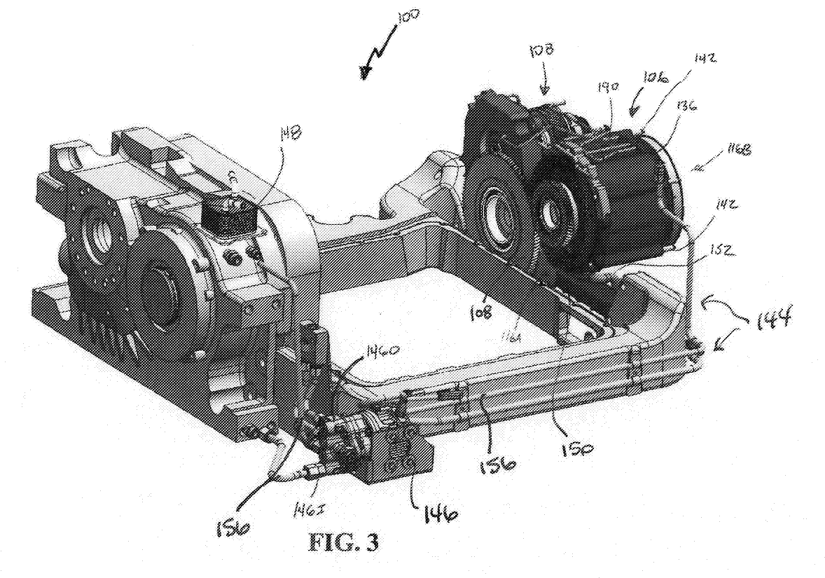

The electric axle assembly 100 includes a housing 104 that supports the electric motor 106 and a gear train 108, as shown in FIGS. 1 and 3. The electric motor 106 is coupled to the housing 104 and in engagement with the gear train 108 to transfer power to the wheels. The gear train 108 generally includes a series of gears and shafts rotatably supported within the housing 104. The electric axle assembly 100 may further include two wheel ends coupled to the housing 104.

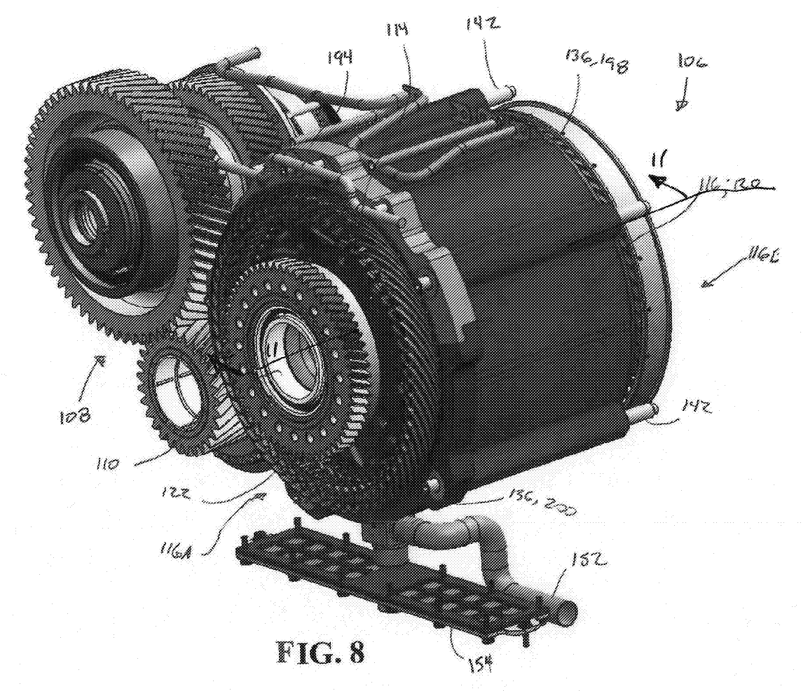

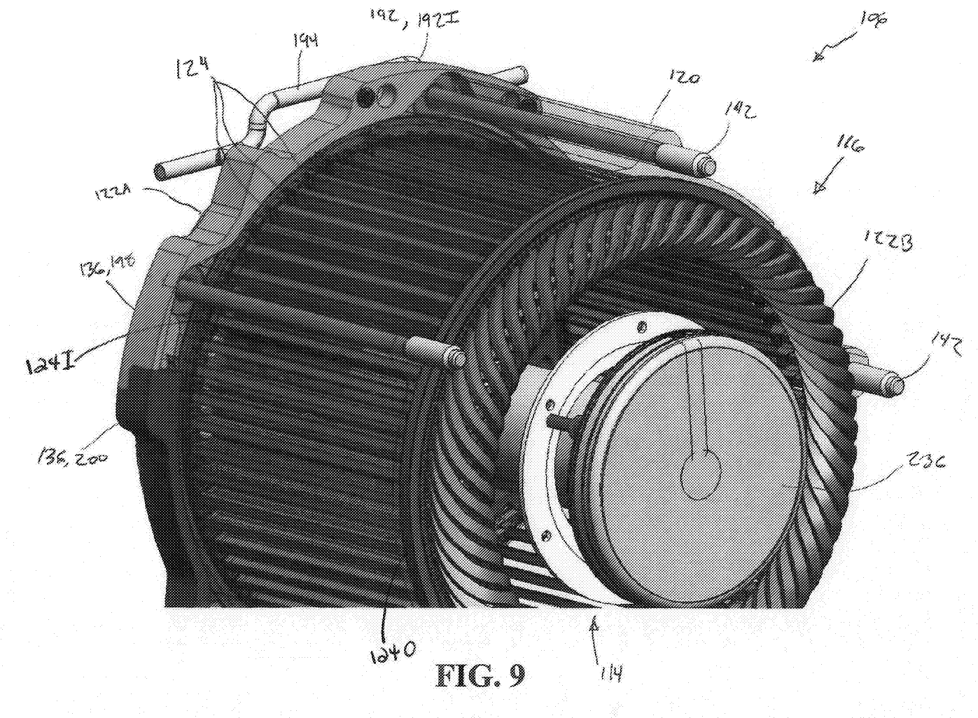

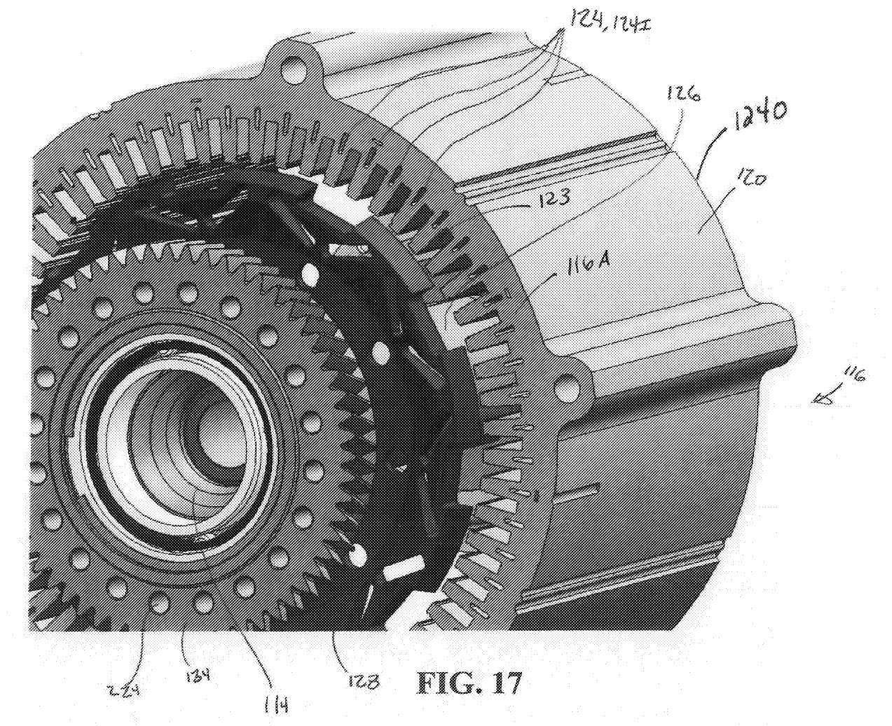

The electric motor 106 includes a stator 116 having a stator core 120 and a rotor 114 adapted for rotation about a rotor axis within the stator core 120, as shown in FIGS. 3 and 8. The stator core 120 includes a series of conductive windings 122 that are disposed about the stator core 120. The windings 122 are wound in a direction generally parallel to the rotor axis. The stator core 120 is formed to include a plurality of longitudinal passageways 124 that are radially arranged about the stator cores 120 and are adapted to permit the flow of a cooling oil through the passageways 124, as shown in FIGS. 9 and 17. The passageways 124 of the stator core 120 extend longitudinally through the stator core 120 and are positioned between the windings 122 such that heat generated by the windings is transferred to the cooling oil to remove heat from the windings 122. The motor also includes a metering ring 158 coupled to a first end of the stator core 120 and a discharge ring 170 coupled to the second end of the stator core 120, as shown in FIGS. 19 and 28. The rings 158, 170 are adapted to direct the flow of cooling oil through the passageways 124 of the stator core 120 to remove heat from the windings generated by operation of the electric motor 106.

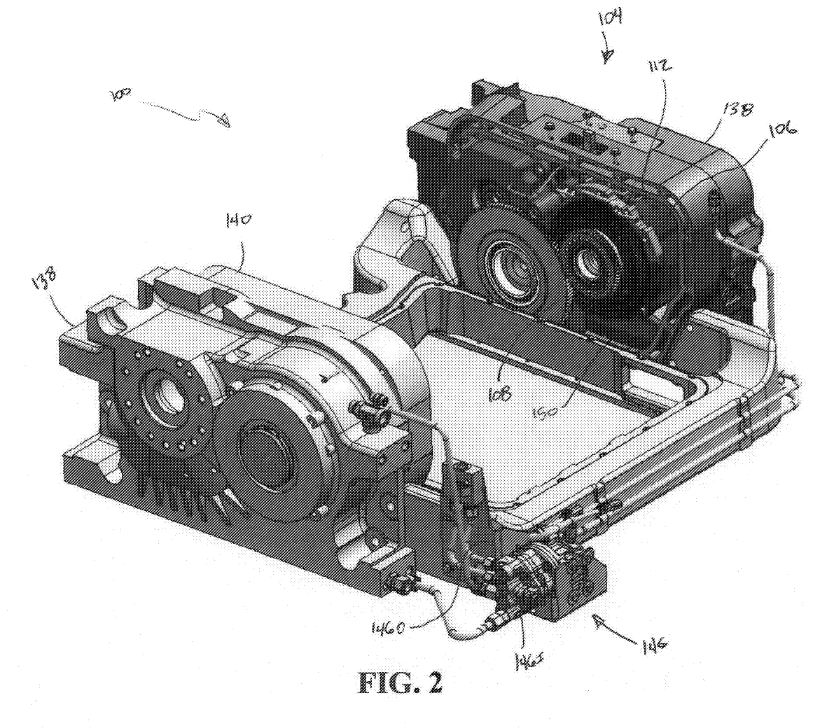

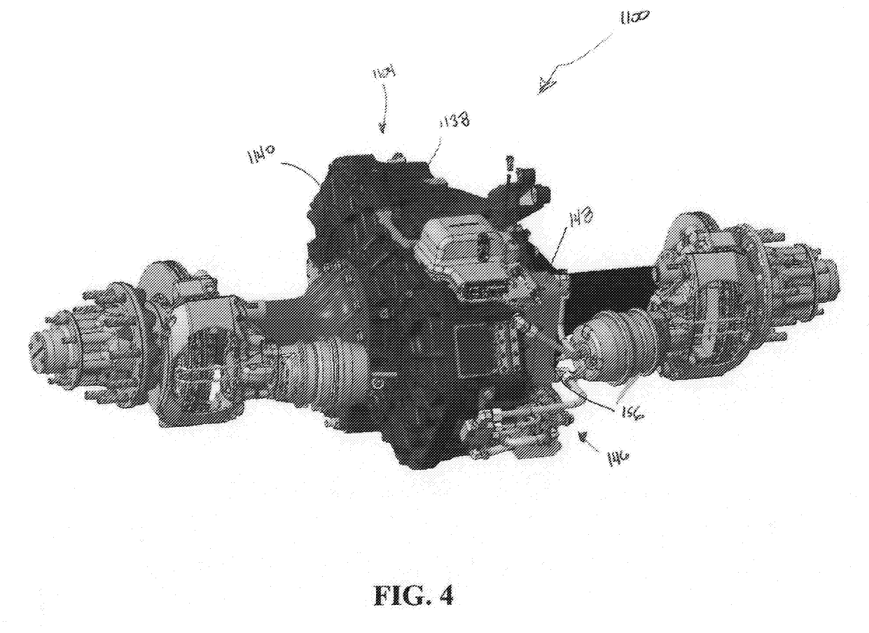

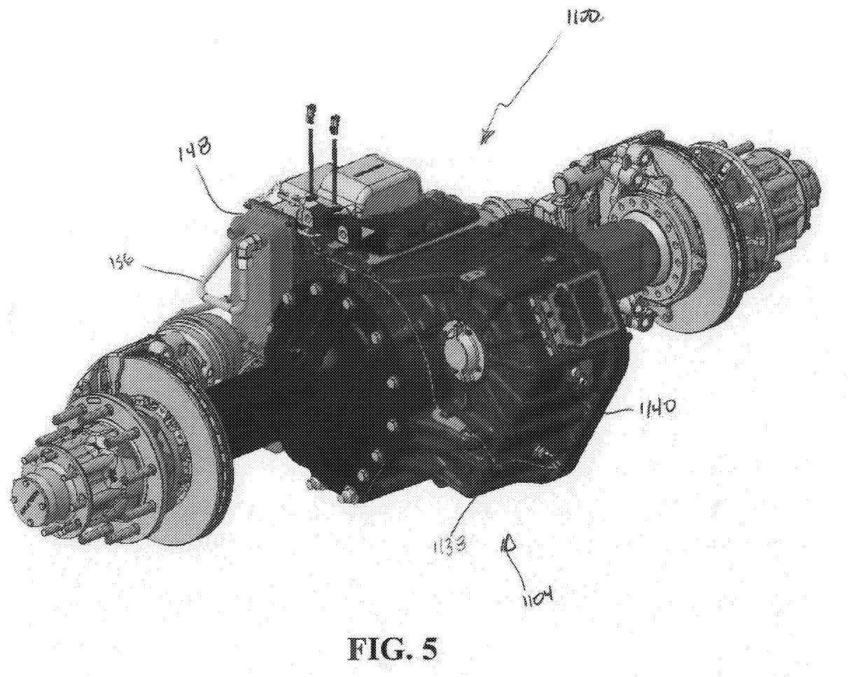

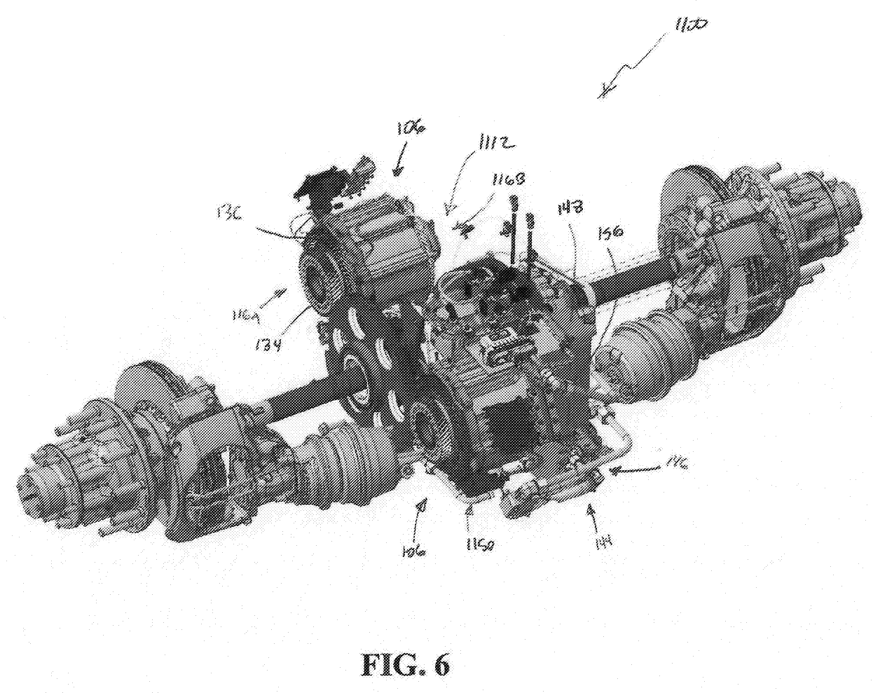

A first electric axle assembly 100 is shown in FIGS. 1-3, the electric axle assembly 100 shown here is configured for use with a low-floor bus and includes two housings 104, each arranged on opposing sides of the electric axle assembly 100, and having a housing case 138 and a cover 140, as shown, for example, in FIG. 2. Each housing 104 is configured to include an electric motor 106 such that the wheels on each side of the axle are driven by a separate motor 106. In a second embodiment, such as shown in FIGS. 4-6, the electric axle assembly 1100 includes a single housing 1104 configured to house and support two electric motors 106.

The second electric axle assembly 1100 is shown in FIGS. 4-6. The second electric axle assembly 1100 is similar to the first electric axle assembly 100 described above in connection with FIGS. 1-3. As such, the components and structural features of the second electric axle assembly 1100 that correspond to the first electric axle assembly 100 are provided with the same reference numerals increased by 1000. Here, unless otherwise indicated, the above description of the first electric axle assembly 100 may be incorporated by reference with respect to the second electric axle assembly 1100 without limitation.

With reference to FIGS. 1-3, the housing 104 includes a housing case 138 and a cover 140. The housing case 138 is formed to include an interior 112 enclosed by the cover 140 and includes the electric motor 106 and gear train 108. The electric motor 106 includes a rotor 114 and a stator 116, as shown in FIG. 8. The rotor 114 is supported for rotation about a rotor axis 118 by bearings 110 in the housing 104. The stator 116 is secured to the housing 104 and disposed about the rotor 114 such that the rotor 114 rotates within the stator 116.

The housing 104 of the axle assembly 100 includes an oil sump 150 within the housing 104 to collect and store lubricating oil, as shown in FIG. 2, which is also used for cooling purposes. Portions of the gear train 108 may partially extend into the oil sump 150 thereby contacting and spreading oil to the gears of the gear train 108. Splash lubrication is used to lubricate the gear train 108. Rotation of the gears splashes oil throughout the interior 112 of the housing 104 lubricating the contact surfaces. Splashed oil drains back into the oil sump 150 where it cools and deaerates.

Likewise, as shown in FIGS. 4-6, the housing 1104 includes a housing case 1138 and a cover 1140. The housing case 1138 is formed to include an interior 1112 enclosed by the cover 1140 and with the electric motor 106 and the gear train 1108 arranged therein. The housing 1104 includes an oil sump 1150 to collect and store lubricating oil.

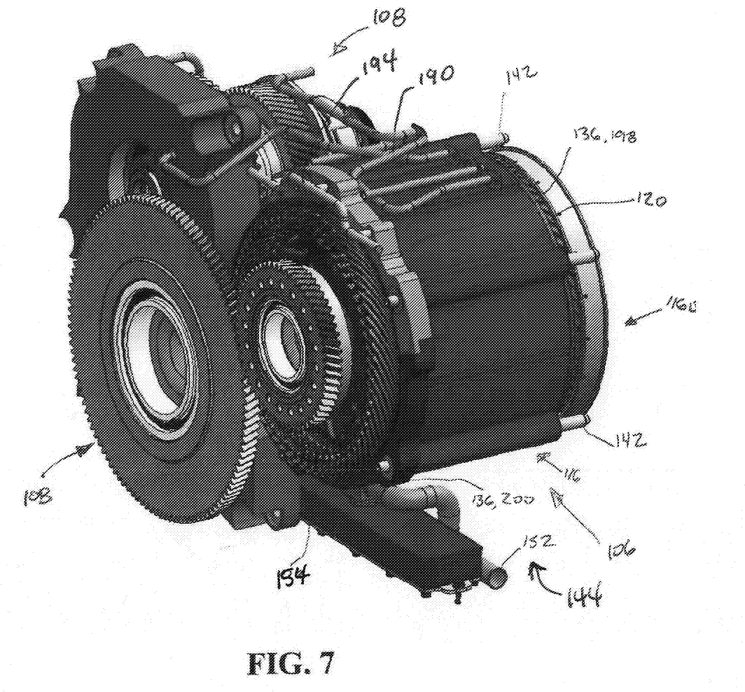

During operation the electric axle assembly 100, 1100 generates heat, primarily through friction between the contact surfaces and electrical current flowing through the electric motors 106. Performance of the electric motors 106 may be improved by preventing the accumulation of excess heat in the electric motors 106 through the use of a cooling system 144 to transfer heat away from the electric motors 106 during operation, as shown in FIG. 7. The cooling system 144 includes a lubricating oil used as a coolant, a pump 146, and a heat exchanger 148, as shown in FIG. 3. Generally, the cooling system 144 reduces the temperature of the electric axle assembly 100 by pumping coolant fluid through the heat exchanger 148 before distributing the coolant fluid to the interior 112 of the housing 104, 1104.

In order to bring the coolant fluid into close contact with the electric motor 106, the oil used to lubricate the electric axle assembly 100 also serves as a coolant. Oil is pumped through the cooling system 144 and supplied to the electric motors 106 as well as the contact surfaces of the gear train 108, as shown in FIG. 3. As such, the pump 146 is an oil pump that pumps oil through the cooling system 144, the heat exchanger 148, and supply lines to direct the oil toward desired components within the interior 112 of the housing 104. The oil pump 146 may be powered by a discrete electric motor or may be driven by the gear train 108. In some embodiments (not shown), the cooling system may comprise two pumps 146, each powered by a respective electric motor.

Referring now to FIG. 7 where the electric motor 106 is shown coupled to the gear train 108 from the first electric axle assembly 100. A clamp ring 136 is arranged at one end of the electric motor 106 between the fasteners 142 and the stator 116. The clamp ring 136 distributes clamping force from the fasteners 142 evenly around the stator 116 to couple the electric motor 106 to the housing 104. The clamp ring 136 is formed to include a clamp ring gallery 192 to direct oil, through the electric motor 106.

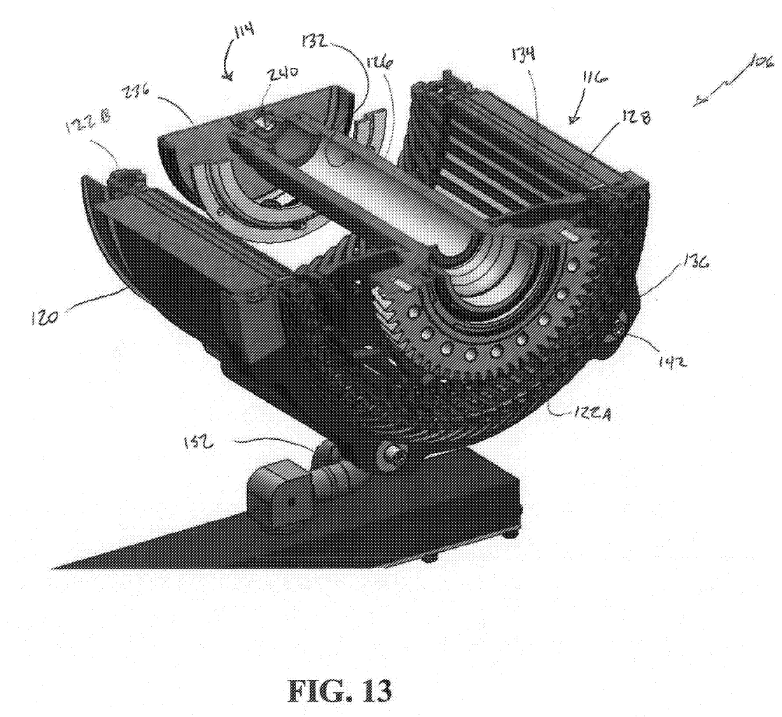

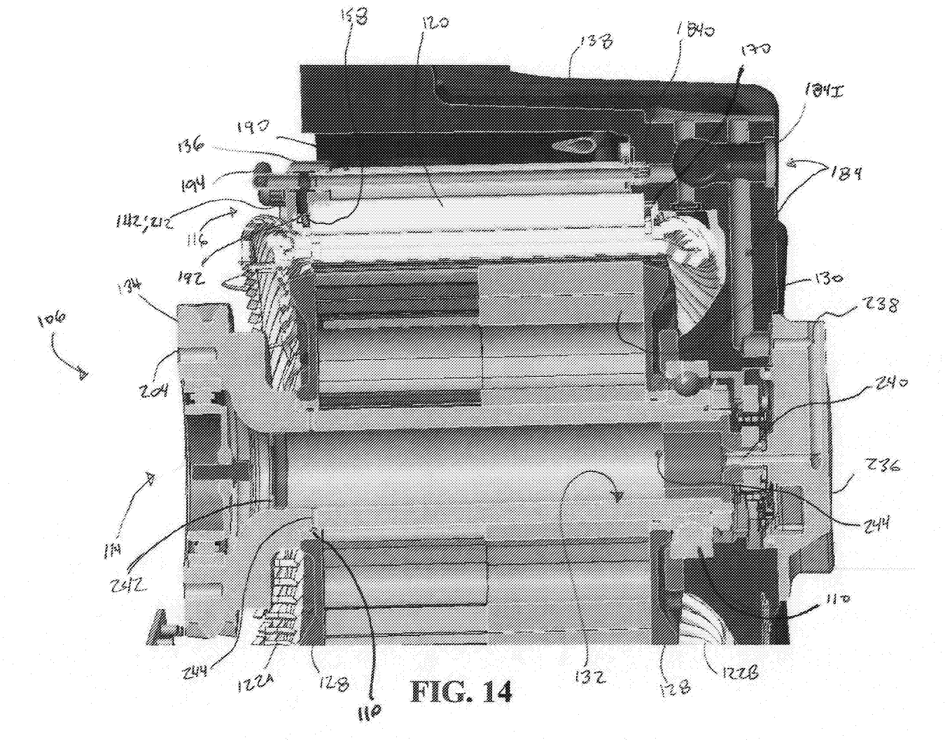

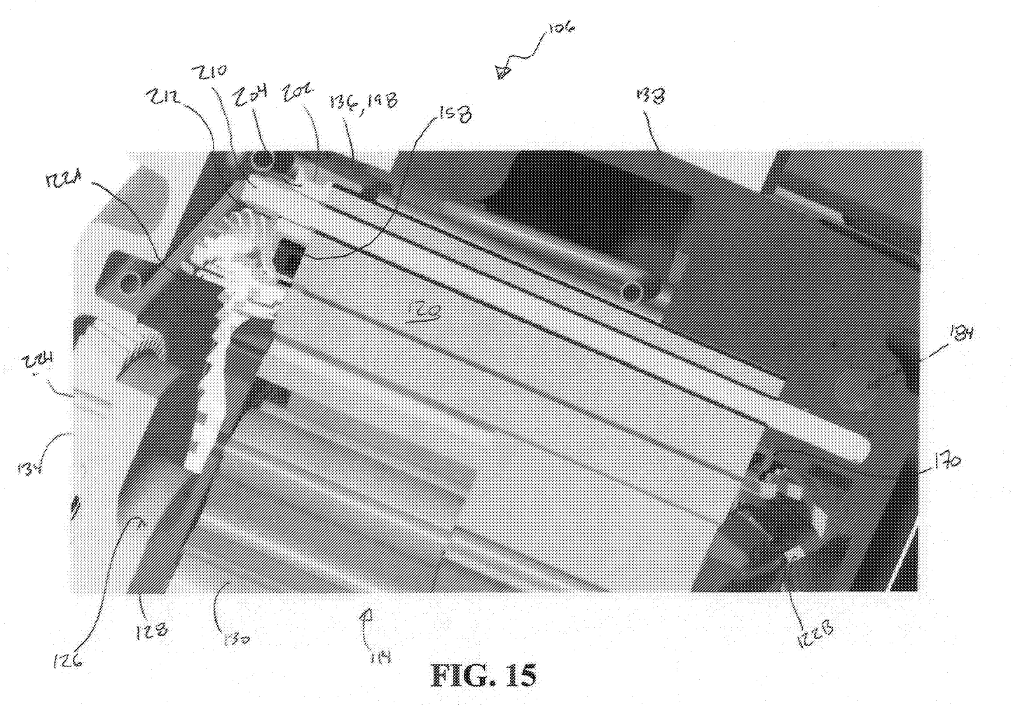

The rotor 114 of the electric motor 106 includes a rotor shaft 126 and a rotor core 128 coupled to the rotor shaft 126, as shown in FIG. 13. A plurality of magnets 130 are disposed in the rotor core 128 and radially arranged about the rotor shaft 126, as shown in FIG. 14. The rotor shaft 126 is formed to include a bore 132 extending therethrough. A drive pinion 134 is coupled to one end of the rotor shaft 126 for engagement with the gear train 108.

The stator 116 of the electric motor 106 includes a stator core 120 and windings 122. The stator core 116 has a generally circular profile that extends from a first end 116A to a second end 116B. The windings 122 are electrical conductors, such as copper wire, which are radially disposed about the stator core 120 and receive electricity to generate a magnetic field for rotating (or braking) the rotor 114. The windings 122 are wound in a direction generally parallel to the rotor axis 118 and protrude from both the first end 116A and the second end 116B.

The stator core 120 is formed to include a plurality of cooling slots or passageways 124 that are radially arranged about the stator core 120, as shown in FIG. 9. The passageways 124 extend longitudinally through the stator core 120 from a slot inlet 124I to a slot outlet 124O. The passageways 124 are arranged so that they are spaced between the windings 122. Viewed from the end, the passageways 124 have a generally oval-shaped cross section, as shown in FIG. 17, however the passageways 124 may have varying degrees of curvature or can be circular. Further, passageways 124 may extend parallel to each other in an axial direction or may form a helix shape around the stator core 120.

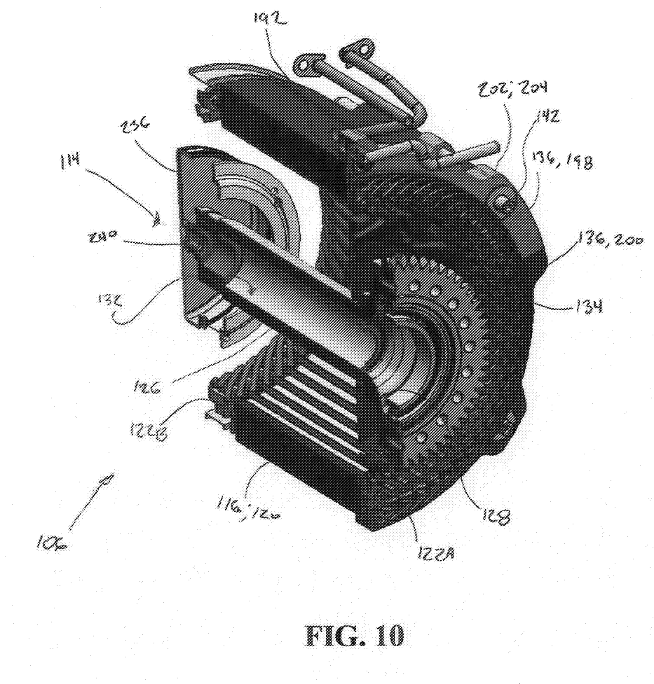

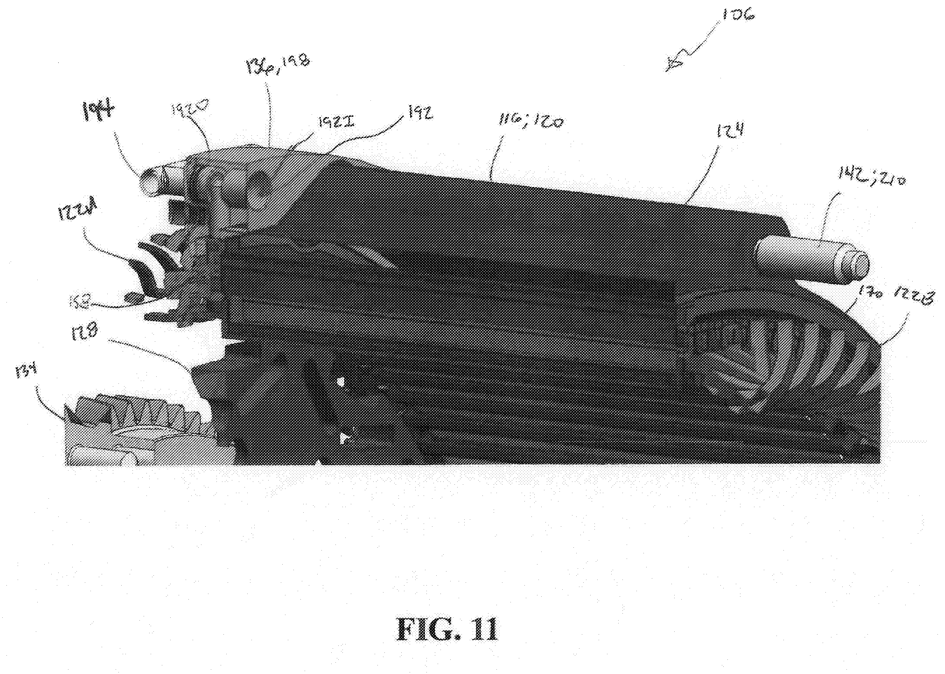

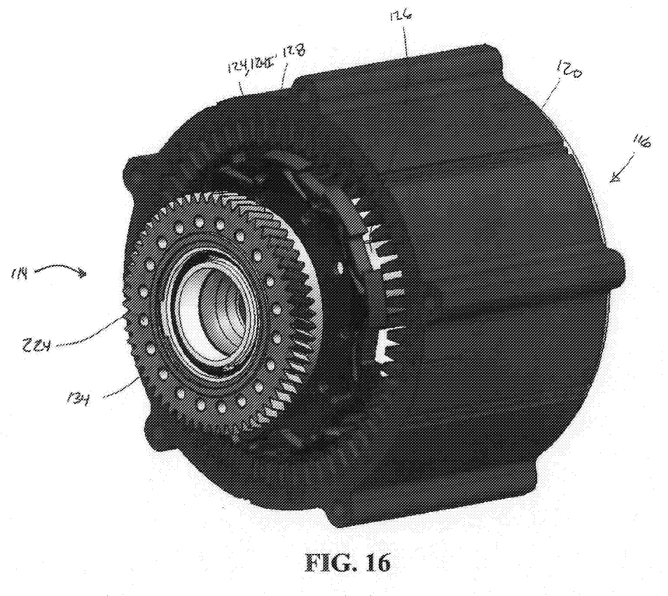

FIGS. 10 and 11 show cross-sectional views of the stator 116 and the clamp ring 136 of the electric motor 106. One of the passageways 124 can be seen spaced from the windings 122 and in fluid communication with the clamp ring gallery 192 to allow fluid from the passageways 124 to enter the clamp ring 136. Best shown in FIGS. 16 and 17, the first end 116A of the stator 116 is exposed to show the passageway inlets 124I radially arranged about the stator core 120 in an alternating fashion with the windings 122 positioned within channels 123. This arrangement allows cooling oil to be located adjacent and parallel to the windings so that heat can be efficiently removed from the stator 116.

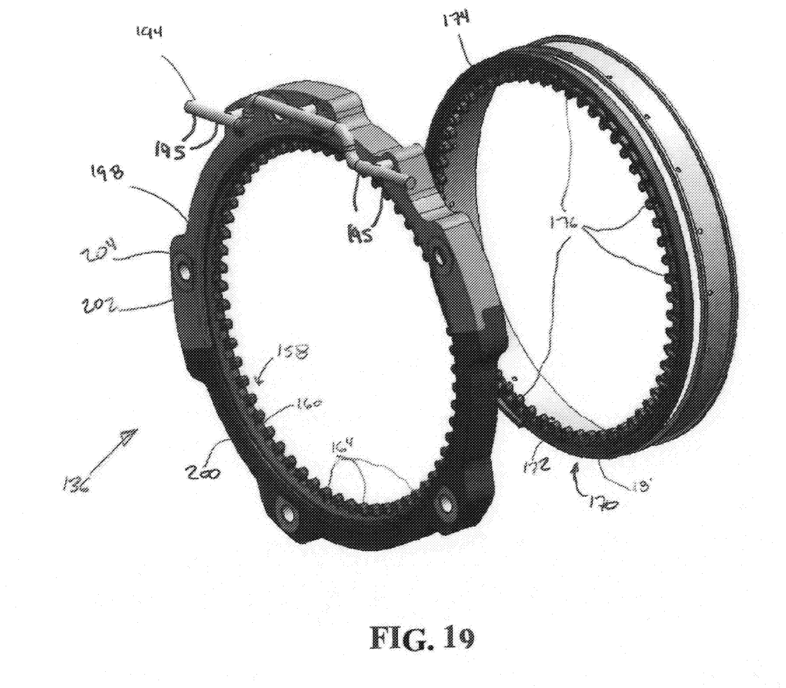

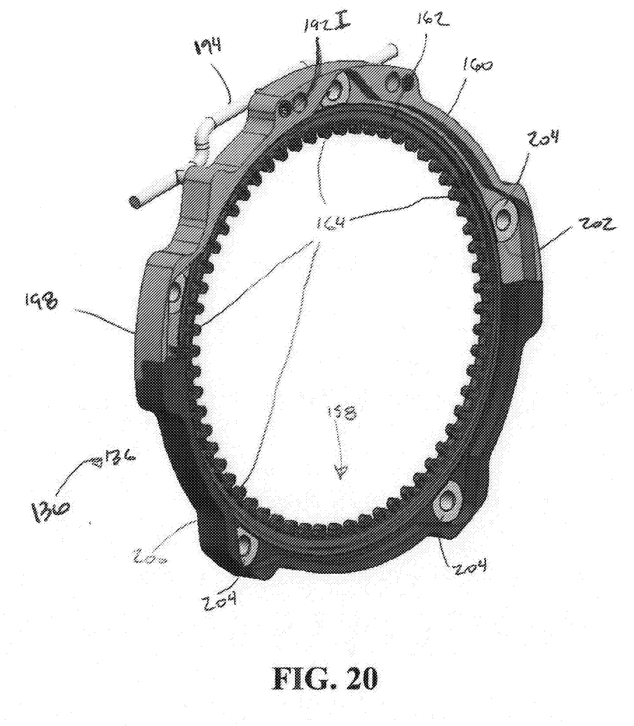

Shown in FIGS. 19 and 20, the clamp ring 136 comprises an upper portion 198 and a lower portion 200, which interlock to form a ring. While a two piece clamp ring is shown, clamp ring 136 can also be a one piece unit. Each portion 198, 200 is formed to include a plurality of openings 202 that receive the threaded fasteners 142 for coupling the electric motor 106 to the housing 104. In one embodiment, the clamp ring 136 is formed from a polymer or composite material, for example by an injection molding process. In another embodiment, the clamp ring 136 is formed from a fiber reinforced polymer such as glass-filled nylon.

Each of the openings 202 includes an insert 204 that prevents deformation of the clamp ring 136 when the threaded fasteners 142 are tightened. The inserts 204 may be formed from a metal (such as steel or aluminum) that can withstand compressive forces from the fasteners 142. The inserts 204 may be fixed to each opening 202 by pressing or insert molding.

Clamp ring 136 is formed to include a clamp ring gallery 192 that routes oil from a clamp ring gallery inlet 192I, through the clamp ring 136, to one or more clamp ring gallery outlets 192O, to be further distributed within the interior 112 of the housing 104, as shown in FIG. 11. The clamp ring gallery 192 may be formed as a cavity during the molding process, with an insert molding process, or by a machining operation.

Shown in FIGS. 7 and 8, oil that is stored in the oil sump 150 of each housing case 138 supplies the pump 146 via a pickup tube 152 in fluid communication with an inlet 146I of the pump 146, as shown in FIG. 2. The pickup tube 152 may include a pickup screen 154 or filter element to help prevent contaminants that have settled in the oil sump 150 from reaching the pump 146. Oil from the oil sump 150 flows through each pickup tube 152 and into the pump 146, which pumps the oil into a main line 156 coupled to the pump outlet 146O as shown in FIG. 3. The main line 156 is coupled between the pump outlet 146O and the heat exchanger 148.

In one embodiment, the cooling system 144 includes a single heat exchanger 148 that cools the oil received from both housings 104 by transferring heat into a second coolant fluid. The heat exchanger 148 is arranged downstream of the pump 146 and removes heat from the oil. The second coolant fluid is part of a second cooling system used in a vehicle to cool other vehicle components, such as the batteries and/or power inverters. In some embodiments more than one heat exchanger 148 may be implemented, such as in an axle with two independent cooling systems 144, to increase the cooling capacity of the cooling system 144. The heat exchanger 148 may utilize a variety of fluids as the second coolant fluid, for example water or antifreeze. The heat exchanger 148 may further be configured as a radiator to cool the oil with a source of flowing air. Furthermore, heat rejection requirements of the heat exchanger 148 may permit the use of a finned oil tank to cool the oil without airflow. Further still, it is contemplated that the cooling system 144 may include a thermostat (not shown) arranged between the oil pump 146 and the heat exchanger 148 preventing oil from flowing into the heat exchanger 148 until a predetermined temperature is reached to assist in maintaining the axle assembly 100 at the optimum operating temperature.

Cooled oil from the heat exchanger 148 flows into a housing case gallery 184 defined in the housing case 138 of the housing 104, as shown in FIG. 14. The housing case gallery 184 may include one or more passages formed in the housing case 138 by casting or by machining Each passage routes oil from a housing case gallery inlet 184I to one or more housing case gallery outlets 184O to be further distributed within the interior 112 of the housing 104.

FIG. 14 shows a cross-sectional view of the housing case 138 taken through one of the housing case galleries 184. The housing case gallery 184 routes oil from the housing case gallery inlets 184I to components of the cooling system coupled to the housing case gallery outlets 184O. The cooling system 144 comprises a crossover tube 190 component that transfers oil from the housing case gallery 184 to the clamp ring gallery 192. The crossover tube 190 extends between a first end coupled to the housing case 138 in fluid communication with the housing case gallery outlet 184O and a second end coupled to the clamp ring 136 in fluid communication with the clamp ring gallery 192. Oil flows from one of the housing case gallery outlets 184O, through the crossover tube 190, into the clamp ring gallery 192. It will be appreciated that oil can be routed to the clamp ring gallery 192 in alternative and additional ways. For example, the housing case gallery 184 may be omitted and oil routed directly from the pump 146 to the clamp ring gallery 192. Likewise, a cover gallery (not shown) may be defined in the cover 140 and in fluid communication with the clamp ring gallery 192 to supply oil to the electric motor 106.

Also shown in FIG. 14 is a resolver cover 236 that may be coupled to the housing case 138. In this embodiment, the resolver cover 236 is formed to include a resolver cover gallery 238 and a bore sprayer 240. The resolver cover gallery 238 is in fluid communication with one of the housing case gallery outlets 184O and receives oil to supply the bore sprayer 240. The resolver cover 236 protrudes through the housing case 138 and into the bore 132 of the rotor 114, with the bore sprayer 240 extending into the bore 132. The bore sprayer 240 supplies oil to the bore 132 to cool the rotor 114 as it rotates in the stator 116.

A lip ring 242 is disposed in the bore 132 opposite the bore sprayer 240 and obstructs oil that has been sprayed into the bore 132 from flowing back to the oil sump 150. The lip ring 242 prevents the oil from draining back to the oil sump 150 too quickly, increasing the time that the oil is in contact with the rotor 114 to remove additional heat. Once enough oil has been sprayed into the bore 132, the oil flows over the lip ring 242, out of the drive pinion 134, and back to the oil sump 150. Further, several feed holes 244 may be defined through the rotor shaft 126 and into the bore 132. The feed holes 244 provide a path for oil to flow from the bore 132 and into the bearings 110. As the rotor 114 rotates, oil is forced through the feed holes 244 and into the bearings 110, reducing friction and heat.

The cooling system 144 further comprises a winding sprayer 194 arranged above the windings 122 of the electric motor 106 and coupled to the clamp ring 136 in fluid communication with one of the clamp ring gallery outlets 192O, as shown in FIGS. 11 & 20. The winding sprayer 194 is an elongated tube having a contoured portion that provides clearance between the winding sprayer 194 and the windings 122 of the electric motor 106. The winding sprayer 194 includes a series of outlet orifices 195 that direct oil onto the windings 122. Oil flows out of clamp ring gallery outlet 192O, through the winding sprayer 194, to the series of outlet orifices 195, as shown in FIG. 19.

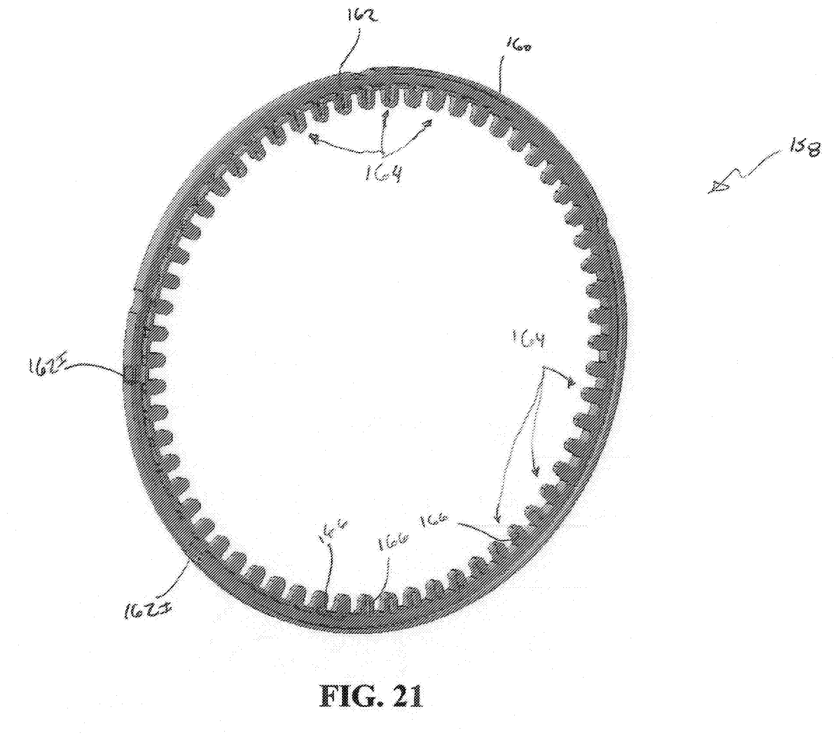

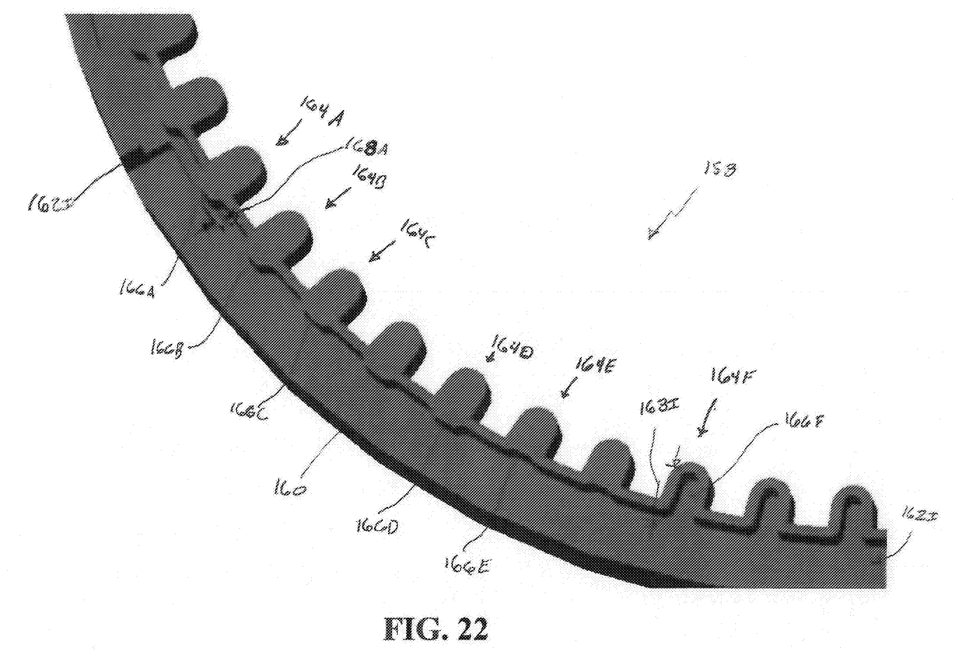

Shown in FIGS. 19-22, the electric motor 106 includes a metering ring 158 to direct the flow of oil into the stator 116 to further cool the electric motor 106. In one embodiment, the metering ring 158 is formed to include an annular body 160 and a coolant channel 162 formed in the meter ring 158. The metering ring 158 directs oil into the stator 116 to cool the stator core 120 and the windings 122 via the coolant passageways 124, as shown in FIG. 17. The metering ring 158 is formed from a polymer material and is coupled to the first end 116A of the stator 116 by use of clamp ring 136 and fasteners 142. The coolant channel 162 faces the stator core 120 and includes one or more inlets 1621 disposed about the annular body 160 that receive oil from the clamp ring gallery 192, as shown in FIG. 22. The metering ring 158 also includes a plurality of fingers 164 radially disposed about the annular body 160 and extending radially inward toward the rotor axis 118. The fingers 164 correspond with the passageways 124 in the stator core 120 such that each finger 164 overlaps a corresponding passageway inlets 124I. Each of the fingers 164 is formed to include a finger channel 166 in fluid communication with the respective slot 124 and the coolant channel 162 such that oil flows from the coolant channel inlet 1621 through the finger channels 166 and to each of the passageways 124. The fingers 164 may be arranged differently than shown and alternatively, the metering ring 158 may be configured such that oil flows directly from the coolant channel 162 into the stator 116, without the fingers 164.

Each finger channel 166 permits oil to flow into the passageways 124 through the slot inlet 124I at a predetermined rate, as shown in FIGS. 17 and 22. In order to equalize the oil flowing into each of the passageways 124 and uniformly cool the stator 116 each finger channel 166 may define an outlet area 168 corresponding to area of the respective inlet 124I that is unoccluded. Finger channels 166 with a relatively larger outlet area 168 allow more oil to flow into the respective slot 124 than finger channels 166 with a relatively smaller outlet area 168.

As oil flows into the coolant channel 162 and around the annular body 160 pressure of the oil decreases with distance from the coolant channel inlet 1621, as shown in FIG. 22. Pressure of the oil in the coolant channel 162 is greatest at the coolant channel inlet 162. Pressure supplying each of the finger channels 166 affects the flow of oil into each slot inlet 124I i.e. the rate of oil flowing through a given area will increase as the pressure increases. To cool the electric motor 106 uniformly the finger channel outlet area 168 is varied according to the distance from the coolant channel inlet 1621 to the respective finger 164.

Referring specifically to FIG. 22, a portion of the metering ring 158 is shown along with several fingers 164A, 164B, 164C . . . 164F each having a respective finger channel 166A, 166B, 166C . . . 166F according to one embodiment. Here, the finger 164F is arranged further from the coolant channel inlet 1621 than the finger 164A and as such, pressure of oil at the finger channel 166F is less than the pressure at finger channel 166A. In order to equalize the flow into the passageways 124 the finger channel outlet area 168F of finger channel 166F is less than the finger channel outlet area 168A of finger channel 166A. The fingers 164 may further be configured to supply oil to the passageways 124 at a rate other than described above. For example, additional oil may be directed to portions of the stator core 120 corresponding to localized areas of increased heat irrespective of the distance between the coolant channel inlet 1621 and the respective finger 164.

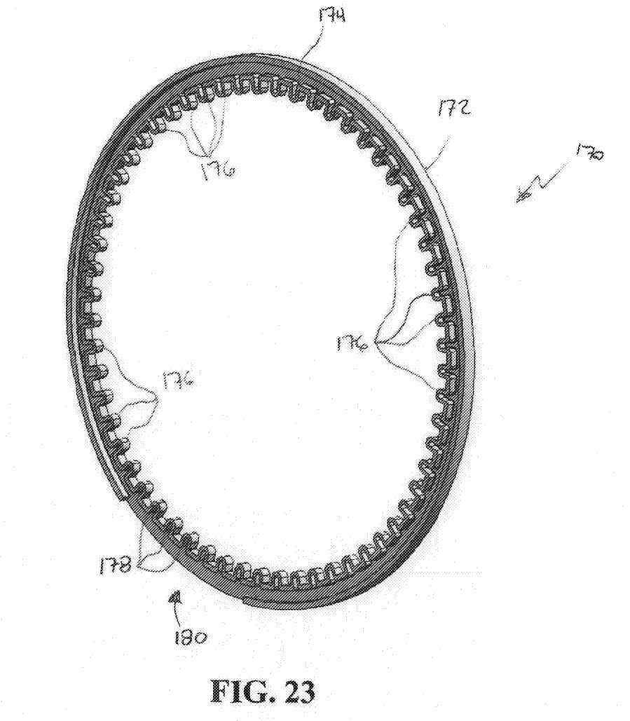

Oil that flows into the passageways 124 is heated by the stator 116 and is discharged through the slot outlets 124O at an opposite end of the stator core 120, as shown in FIGS. 14 and 23. The electric motor 106 includes a discharge ring 170 arranged about the rotor axis 118 and coupled to the second end 116B of the stator 116 by use of clamp ring 136. The discharge ring 170 includes an annular body 172 formed to include a collection channel 174 in a side of the annular body 172 facing the stator core 120. The discharge ring 170 further includes a plurality of fingers 176 radially arranged about the annular body 172 and extending toward the rotor axis 118. Each of the fingers 176 corresponds with one of the passageways 124 in the stator core 120 such that each finger 176 is adjacent to one of the slot outlets 124O, which is similar in arrangement to the metering ring 158. Each of the fingers 176 is formed to include a finger channel 178 in fluid communication with the respective slot 124 and the collection channel 174 such that oil flows from each of the passageways 124 out of the respective slot outlet 124O, into the corresponding finger channels 178 to the collection channel 174. The discharge ring 170 may be formed from a polymer material, or an elastomeric material such as rubber.

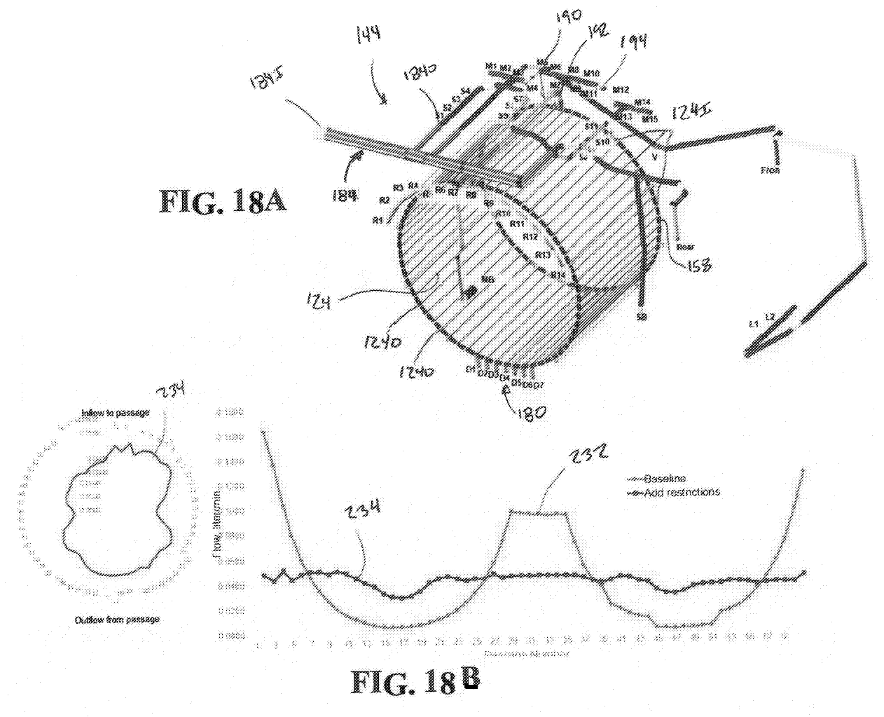

FIGS. 18A and 18B show exemplary configurations of the cooling system 144 and the effect of oil flowing through the passageways 124 in the stator core 120. Specifically, FIG. 18A is schematic view of the cooling system 144 showing the arrangement of the passageways 124 around the stator core 120. Oil flow from the housing case gallery 184 feeds the clamp ring gallery 192, which supplies oil to the metering ring 158. FIG. 18B shows a graph of flow rate through each of the cooling passages (slots) 124. FIG. 18B also shows a comparison of flow rate through the passageways 124 between a metering ring 158 without restrictions (baseline) 232 added to the finger channels 166 and a metering ring 158 with restrictions 234 added to the finger channels 166. The restrictions equalize the flow rate to each slot 124 around the stator 116.

Shown in FIGS. 19 and 23, the discharge ring 170 directs oil from the passageways 124 toward the oil sump 150, where oil will pool in order to be recirculated through the cooling system 144. To direct oil toward the oil sump 150, the discharge ring 170 is formed to include a drain slot 180. The drain slot 180 is in fluid communication with the collection channel 174 and arranged near a lower portion of the discharge ring 170. Gravity draws the oil from an upper portion of the collection channel 174 to the lower portion where it passes through the drain slot 180 and into the oil sump 150.

Referring specifically to FIG. 23, the discharge ring 170 is shown along with several fingers 176A, 176B, 176C each having a respective finger channel 178A, 178B, 178C, according to one embodiment. Oil flows from the passageways 124 into the respective finger channel 178 and into the collection channel 174. Gravity and pressure cause the oil from the collection channel 174 to flow toward the drain slot 180 and into the oil sump 150.

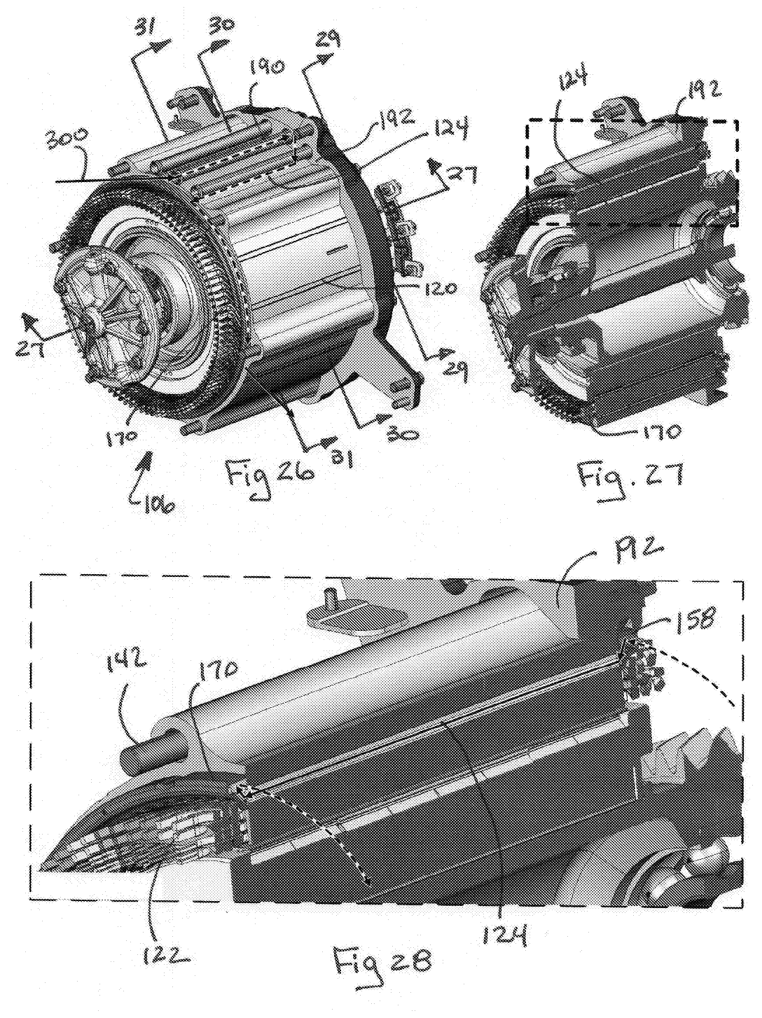

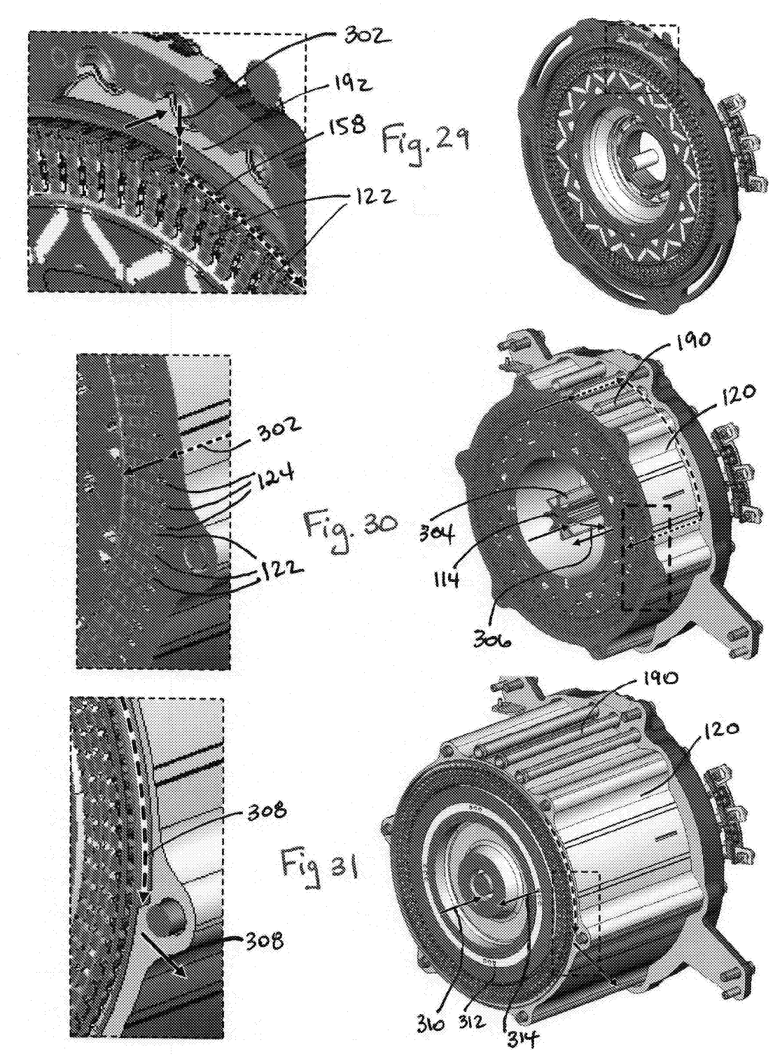

FIG. 26 illustrates cooling oil entering crossover tube 190, as indicated by arrow 300 to the clamp ring gallery 192 and from the clamp ring gallery 192 and metering ring 158 into the passageways 124 of the stator core 120. The oil passes through the passageways 124 around the stator core 120 to the discharge ring 170 where the oil is returned back to the sump of the housing 104, as shown in FIGS. 27 and 28. Cooling oil enters clamp ring gallery 192 and metering ring 158 and into passageways 124 positioned between the windings 122, as shown by the arrows 302 in FIGS. 29 and 30. The rotor 114 includes impeller blades 304 that are adapted to direct cooling oil radially outwardly as illustrated by arrow 306 in FIG. 30. FIG. 31 illustrates oil exiting the passageways 124 into discharge ring 170 as indicated by arrow 308. Oil entering rotor 124 is indicated by arrow 310 and exits from openings 312 as indicated by arrow 314.

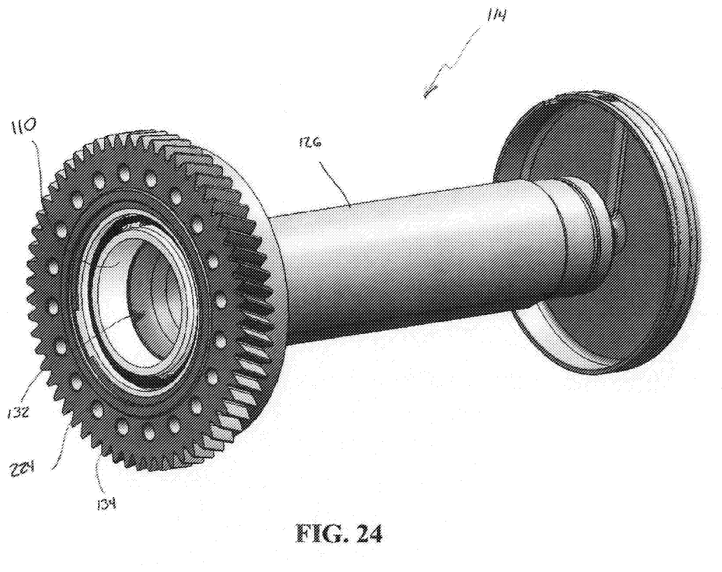

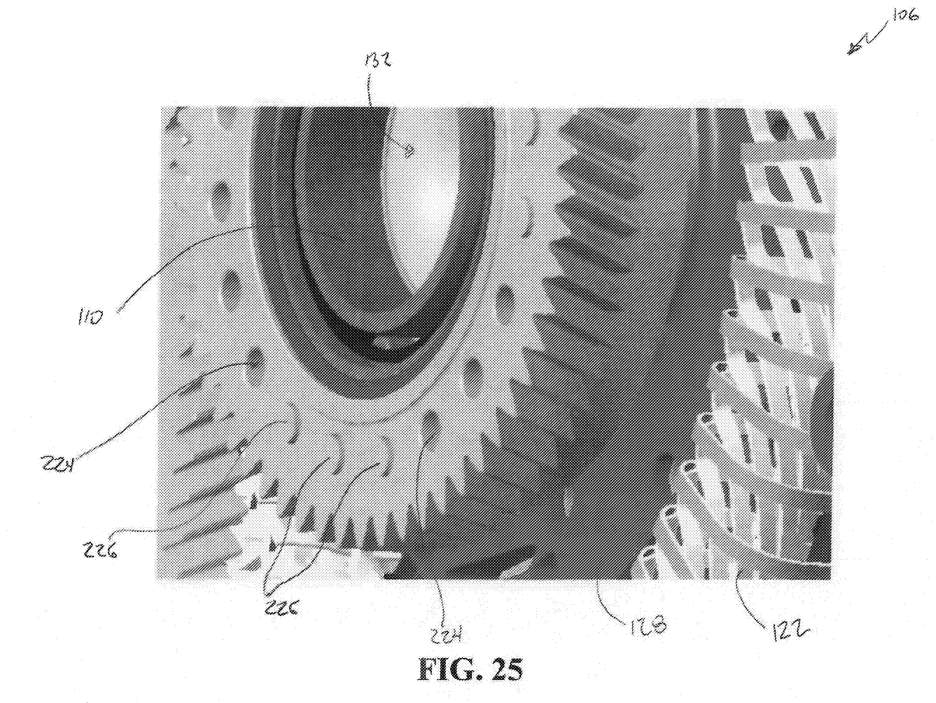

FIGS. 24 and 25 are the rotor shaft 126 for the electric motor 106. As mentioned above the drive pinion 134 that engages the gear train 108 is coupled to the rotor shaft 126. In this embodiment that drive pinion 134 is integrally formed on the rotor shaft 126, which increases the strength and durability of the rotor shaft 126. The drive pinion 134 is formed to include a plurality of balancing holes 224 radially arranged about the rotor axis 118. The balancing holes 224 permit the rotor 114 to be balanced during manufacture to reduce undesirable vibrations during operation. The balancing holes 224 receive balancing weights 226 as necessary to distribute weight around the rotor axis 118. FIG. 25 shows balancing weights 226 in several of the balancing holes 224. Each of the balancing weights 226 may be a different weight in order to correct for small variations in manufacturing. More or fewer balancing weights 226 may be used than are shown in FIG. 25, including zero balancing weights 226. The balancing weights 226 may be coupled to the drive pinion 134 by welding, pressing, peening, threads, and the like.

Generally, the vehicle includes a chassis upon which a body and other equipment may be supported. For example, a cab, a cargo box, a lift boom, or a hitch system may be mounted to the chassis. The chassis includes frame rails; suspension components such as springs, dampers, and trailing arms; and brake components such as air cylinders, brake calipers, brake rotors, brake drums, brake hoses, and the like. The electric axle assembly 100 is generally mounted perpendicular to the frame rails such that the vehicle travels in a direction aligned with the frame rails. Accordingly, an axle centerline axis 102 is defined through the electric axle assembly 100 and extends outwardly from sides of the vehicle.

The electric axle assembly 100 may be configured for “single-wheel” applications and “dual-wheel” applications. In “single-wheel” applications one wheel is coupled to each end of the electric axle assembly 100. Likewise, in “dual-wheel” applications, wheels are arranged in pairs at each end of the electric axle assembly 100. Vehicles requiring increased payload and towing capacity are one example of a “dual-wheel” application. Vehicles that require a further increased payload/towing capacity may be equipped with two or more electric axle assemblies 100. Some vehicles may require drive devices other than wheels. For example, crawler tracks or rail wheels may be coupled to the electric axle assembly 100 to propel the vehicle over loose terrain and along railways, respectively. The electric axle assembly 100 may be mounted to the vehicle both in the front and in the rear to realize various drive types such as front-wheel drive, rear-wheel drive, and all/four-wheel drive.

Vehicle performance is optimized when contact between the wheels and the ground is uninterrupted over various surfaces. In order to more easily follow the ground, a suspension system movably couples the electric axle assembly 100 to the frame rails. The suspension system allows the electric axle assembly 100 to move relative to the frame rails and urges the wheels toward the ground when the vehicle encounters imperfections in the ground. The suspension system may include springs and dampers, which absorb movement and improve ride quality; control arms that constrain the movement of the electric axle assembly 100; and other elements as determined by the application such as steering and kinematic linkages. The electric axle assembly 100 may also be mounted to a vehicle that was not originally equipped with an electric axle assembly 100. The electric axle assembly 100 can be retrofit to these vehicles to offer an electric driveline upgrade.

The electric axle assembly 100 is capable of being utilized in both hybrid-electric vehicles and fully-electric vehicles. In a fully-electric vehicle, electricity to power the electric axle assembly 100 may be stored in a battery mounted to the chassis. Alternatively, electricity may be supplied from an external power source, such as an overhead wire or third rail system. If the vehicle is configured as a hybrid-electric vehicle an internal combustion engine may be mounted to the chassis and coupled to an electric motor capable of generating electricity, which may power the electric axle assembly 100 directly or be stored in a battery.

It should be appreciated that the electric motor 106 may be used interchangeably with either of the electric axle assemblies 100, 1100. The electric motor 106 may be coupled to the housing 104, 1104 using threaded fasteners 142, which extend through the stator 116 and into the housing case 138, 1138.

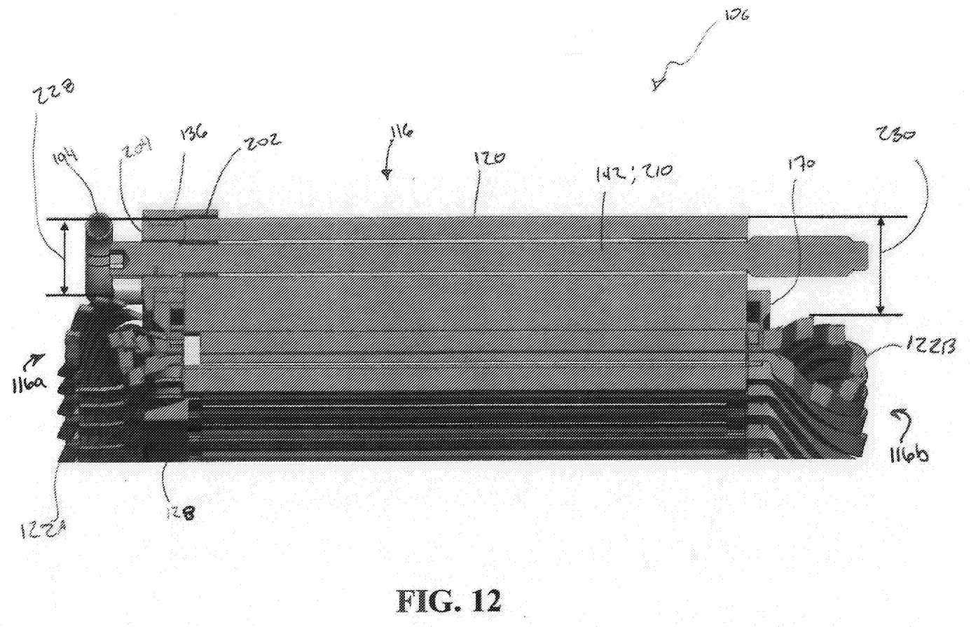

FIG. 12 shows a cross-sectional view of the electric motor 106 taken along a plane intersecting with one of the elongated fasteners 142. Here, the stator core 120, the rotor core 128, and the windings 122 are cut by the plane. In order to efficiently package the electric motor 106, reduce complexity during assembly, and provide necessary clearances between rotating components, the windings 122 are shaped differently at the first end 116A of the stator 116 than at the second end 116B of the stator 116. Specifically, the windings have a first end portion 122A and a second end portion 122B, with the first end portion 122A having a different profile and orientation than the second end portion 122B. More specifically, the first end portion 122A is spaced at a first distance 228 from an outer portion of the stator core 120 and the second end portion 122B is spaced at a second distance 230 from the outer portion of the stator core 120. Here, the both the first end portion 122A and the second end portion 122B of the windings 122 are formed into coil shapes, with the second end portion 122B formed nearer to the rotor axis 118 than the first end portion 122A. By increasing the second distance 230 between the second end portion 122B and the outer portion of the stator core 120 the fasteners 142 may be arranged closer to the rotor axis 118 to allow the size of the stator 116 to be maximized.

In the embodiment shown throughout the Figures, the fasteners 142 comprise elongated studs 210 and nuts 212 that are radially arranged about the rotor axis 118 to couple the electric motor 106 to the housing 104. The studs 210 are threaded into the housing case 138 and extend through the stator 116 to protrude from the clamp ring 136 in the direction of the cover 140. The nuts 212 are threaded onto the studs 210 to clamp the electric motor 106 and the clamp ring 136 to the housing case 138. Due to the configuration of the windings 122, utilizing the studs 210 and nuts 212 allows the size of the electric motor to be further optimized by arranging the fasteners 142 nearer to the rotor axis 118 than would otherwise be possible.

As mentioned above, the electric axle assembly 100, 1100 utilizes the gear train 108, 1108 to transfer torque and power to the wheels. Typically, bearings 110 are used to reduce friction between rotating components of the gear train 108, 1108. Various types of bearings 110 may be used depending on requirements of the application, for example, journal (plain) bearings, roller bearings, ball bearings, etc. Friction is further reduced through the use of a lubricant, such as oil. Oil is supplied to contact surfaces between components, such as gear teeth and bearings 110, to reduce wear and heat caused by movement within the gear train 108, 1108.

Various features of the invention have been particularly shown and described in connection with the illustrative embodiment of the invention, however, it must be understood that these particular arrangements may merely illustrate, and that the invention is to be given its fullest interpretation within the terms of the appended claims.

1. An electric motor for an axle assembly comprising:
a stator having a stator core, and a rotor adapted for rotation about a rotor axis within the stator core;
a plurality of magnets associated with and positioned around the rotor, the magnets adapted to rotate with the rotor;
a plurality of conductive windings disposed about the stator core, the windings being wound in a direction generally parallel to the rotor axis and protrude from first and second ends of the stator core; and
the stator core is formed to include a plurality of longitudinal passageways that are radially arranged about the stator core and are adapted to permit the flow of a cooling fluid through the passageways, the passageways extend longitudinally through the stator core and are positioned between the windings such that heat generated by the windings is transferred to the cooling fluid to remove heat from the windings.

2. The electric motor of claim 1, further including a clamp ring coupled to a first end of the stator core and a metering ring coupled to the clamp ring, the metering ring adapted to direct the flow of cooling fluid into the stator core to remove heat from the windings from heat generated by operation of the electric motor.

3. The electric motor of claim 2, wherein the metering ring defines an annular body formed to include a coolant channel to allow cooling fluid to be transmitted about the ring.

4. The electric motor of claim 3, wherein the metering ring includes a plurality of fingers radially disposed about the metering ring, the fingers aligned with the passageways formed in the stator core.

5. The electric motor of claim 4, wherein a plurality of fingers each include a finger channel that is fluidly connected to the coolant channel to permit fluid from the coolant channel to flow into the passageways formed in the stator core.

6. The electric motor of claim 5, wherein the finger channels vary in channel area to equalize the volume of cooling liquid flowing into the passageways of the stator core.

7. The electric motor of claim 4, further including a discharge ring coupled to a second end of the stator core, the discharge ring adapted to direct the flow of cooling fluid exiting the passageways of the stator core.

8. The electric motor of claim 7, wherein the discharge ring includes a plurality of discharge fingers radially disposed about the discharge ring, the discharge fingers aligned with the passageways formed in the stator core.

9. The electric motor of claim 1, further including a winding sprayer that includes an elongated tube having outlet orifices that are adapted to direct cooling liquid onto windings at the ends of the stator.

10. The electric motor of claim 1, wherein the rotor includes a central bore and the electric motor further includes a bore sprayer that supplies cooling fluid to the bore to cool the rotor.

11. The electric motor of claim 10, wherein the rotor includes a lip ring disposed in the bore, opposite the bore sprayer, the lip ring adapted to retain the oil before it exits the bore of the rotor.

12. An electric motor for an axle assembly comprising:
a stator having a stator core, and a rotor adapted for rotation about a rotor axis within the stator core;
a plurality of magnets associated with and positioned around the rotor, the magnets adapted to rotate with the rotor;
a plurality of conductive windings disposed about the stator core, the windings being wound in a direction generally parallel to the rotor axis and protrude from first and second ends of the stator core;
the stator core is formed to include a plurality of longitudinal passageways that are radially arranged about the stator core and are adapted to permit the flow of a cooling fluid through the passageways, the passageways extend longitudinally through the stator core and are positioned between the windings such that heat generated by the windings is transferred to the cooling fluid to remove heat from the windings; and
a clamp ring coupled to a first end of the stator core and a metering ring coupled to the clamp ring, the metering ring adapted to direct the flow of cooling fluid into the stator core to remove heat from the windings generated by operation of the electric motor.

13. The electric motor of claim 12, wherein the metering ring defines an annular body formed to include a coolant channel to allow cooling fluid to be transmitted about the ring.

14. The electric motor of claim 13, wherein the metering ring includes a plurality of fingers radially disposed about the metering ring, the fingers aligned with the passageways formed in the stator core.

15. The electric motor of claim 14, wherein a plurality of fingers each include a finger channel that is fluidly connected to the coolant channel to permit fluid from the coolant channel to flow into the passageways formed in the stator core.

16. The electric motor of claim 15, wherein the finger channels vary in channel area to equalize the volume of cooling liquid flowing into the passageways of the stator core.

17. The electric motor of claim 14, further including a discharge ring coupled to a second end of the stator core, the discharge ring adapted to direct the flow of cooling fluid exiting the passageways of the stator core.

18. The electric motor of claim 17, wherein the discharge ring includes a plurality of discharge fingers radially disposed about the discharge ring, the discharge fingers aligned with the passageways formed in the stator core.

19. The electric motor of claim 12, further including a winding sprayer that includes an elongated tube having outlet orifices that are adapted to direct cooling liquid onto windings at the ends of the stator.

20. An electric motor for an axle assembly comprising:
a stator having a stator core, and a rotor adapted for rotation about a rotor axis within the stator core;
a plurality of magnets associated with and positioned around the rotor, the magnets adapted to rotate with the rotor;
a plurality of conductive windings disposed about the stator core, the windings being wound in a direction generally parallel to the rotor axis and protrude from first and second ends of the stator core; and
the stator core is formed to include a plurality of longitudinal passageways that are radially arranged about the stator core and are adapted to permit the flow of a cooling fluid through the passageways, the passageways extend longitudinally through the stator core and are positioned between the windings such that heat generated by the windings is transferred to the cooling fluid to remove heat from the windings;
a metering ring coupled to a first end of the stator core and a discharge ring coupled to a second end of the stator core, the rings adapted to direct the flow of cooling fluid through the passageways of the stator core to remove heat from the windings generated by operation of the electric motor.
